(19) United States
(12) Patent Application Publication
(10) Pub. No.: US 2004/0167832 A1
(43) Pub. Date: Aug. 26, 2004

(54) Method and data processing system for managing products and product parts, associated computer product, and computer readable medium

(76) Inventor: Volkmar Wille, Wien (AT)

Correspondence Address: LERNER AND GREENBERG, P.A., POST OFFICE BOX 2480, HOLLYWOOD, FL, 33022-2480, US

(21) Appl. No.: 10/757,822

(22) Filed: Jan. 15, 2004

Related U.S. Application Data
(63) Continuation-in-part of application No. 10/454,520, filed on Jun. 4, 2003.

(30) Foreign Application Priority Data
May 26, 2003 (AT) A 810/2003
Feb. 6, 2003 (AT) A 189/2003

(51) Int. Cl. G06F 17/60

(52) U.S. Cl. 705/28

(57) ABSTRACT

A system for the management of products and product parts, and for monitoring operations during the repair of devices or sites containing the products or product parts. If a device or a site is to be repaired, an associated first database extract is created from a database that contains identifiers and associated material master data. The extract contains the serial numbers and associated material master data and includes the warranty data of the device or site. A symbol or an image is created from the data of the first database extract, and can be represented on an input and output device. One or more serial numbers of the device or of the site are input into the input and output device for data adjustment. The part to be repaired is removed (repair part) and a replacement part (spare part) is input into the input and output device and stored. An altered image is thus produced and an altered database extract corresponding to the repaired device or site is generated from said altered image and stored in the database.

### CROSS-REFERENCE TO RELATED APPLICATIONS

This application is a continuation-in-part of my copending application Ser. No. 10/454,520, filed Jun. 4, 2003, which is herewith incorporated in its entirety. This application also claims the benefit, under 35 U.S.C. § 119, of Austrian patent application A 810/2003, which is herewith incorporated in its entirety as well.

### BACKGROUND OF THE INVENTION

### Field of the Invention

The invention relates to a system and a data processing system for the management of products and product parts and/or the serial numbers assigned to the products and product parts, and also for the monitoring and control of the operations during the repair of devices or sites which contain the products or product parts. Serial numbers and associated material master data are stored in a database and the warranty or guarantee data are part of the database. When warranty data are mentioned below, this equally relates to guarantee data.

For a concern that is active at an international level, such as e.g. telecoms companies, complete acquisition of the supplied and delivered or installed products or product parts and the serial numbers thereof is of essential importance. It makes a significant contribution to business processes such as, for example, quality, accounting (billing), fraud, stock-keeping or maintenance logistics. What are involved in this case are a multiplicity of different serial numbers such as e.g. those according to the standards IMEI, SIM card or companies' in-house serial numbers of vouchers, and the like.

Spare parts and accessories of products or installed devices have different serial numbers with a different construction, check rules and vendor-specific fashioning. In other words, the requirements made of serial number management consist in a high flexibility and adaptability to existing business processes and in the definition of the material flow points at which the serial numbers must be acquired.

Furthermore, there is the requirement of supplying serial numbers to external systems such as e.g. for accounting or commissioning computers, etc. in short cycle times.

The requirements of the various company software modules likewise have to be taken into account. Thus, for instance, stock logistics possibly with a storage location management make different requirements than maintenance logistics with the technical locations and equipment articles.

The recording of the serial number history, that is to say the chronology associated with each serial number, must be ensured since it provides important data for other business processes, such as bonus, commission payments and fraud investigation. This means that a relatively large volume of data has to be made available within a very short time including via web applications (Internet or Intranet).

Such a system is described in my above-mentioned copending application Ser. No. 10/454,520 (and its Austrian counterpart 189/2003).

### SUMMARY OF THE INVENTION

The present invention relates to problems which occur in the context of repair handling and in the context of warranty handling for products and product parts, in particular in installed sites.

The invention relates in particular to installed devices of telecommunications companies, without being restricted thereto. Such devices are e.g. the many radio stations which are distributed throughout the area. A failure or a disturbance of a radio station is usually reported by the latter itself to the central station.

With the above and other objects in view there is provided, in accordance with the invention, a product management method for managing products, product parts, and identifiers associated with the products and product parts, and for monitoring and controlling operations during a repair of a device or site containing the products or product parts, wherein the identifiers and associated material master data are stored in a database. The method, and an associated product management system, may be characterized as follows:

An associated first database extract is created by the device or site to be repaired from the database, the extract containing the serial numbers and associated material master data including the warranty data of the device or site.

A symbol or a series of symbols (image) are created from the data of the first database extract, and can be represented on an input and output device and are stored in an image data memory.

One or more serial numbers of the device or of the site are input into the input and output device for the purpose of data adjustment.

The product or product part to be repaired is removed as repair part and the spare part with its serial numbers is input into the input and output device and stored.

An altered image is produced and an altered database extract corresponding to the repaired device or site is generated from said altered image.

The altered database extract is stored in the database memory.

According to the invention, an extract is created from the database, which extract reproduces the device situation of the site to be repaired, e.g. of an antenna site. In other words, the data necessary for the respective transmitting station are received by or transmitted to the technician on a suitable device, such as e.g. his laptop. With this database extract (image snap shot), the technician is already provided at an early stage with knowledge concerning the apparatus construction of the site to be repaired.

The technician removes the apparently defective part on site and takes the corresponding data e.g. about the serial number of the part locally to his laptop. The check of the serial number is sufficient to reveal whether this is actually the correct transmitting station or not.

The input of the serial number of the new exchanged part already involves checking whether this part is actually permitted or intended to be installed at the location. All this is done on the basis of the assignment date of the serial numbers to the material master data, said assignment data being contained in the database.

The original data in the database are compared with the technician's changed data using a synchronization algorithm. In this case, the business management entries may also run in the background and it is also possible to check and handle the question of a guarantee, namely if the part to be exchanged is still under warranty.

A large database containing the data of all the radio stations is designated as equipment DB. The data of the respective stations are read therefrom and this original database extract represents a so-called image. This image may also be represented symbolically in order to be able to be read more easily. The image is altered by the technician on the input device insofar as he scans in e.g. the serial number of the installation location (RACK) and then scans in the serial number of the new part, which results in a new image with the associated, partly new serial numbers. The synchronization subsequently takes place by processing the difference between the original image and the image. The new image is stored as new valid original taking account of the present changes in the database.

The difference between the images is also used, in the further sequence to determine whether a warranty case is present here, by comparing the material master data, e.g. time of sale, length of warranty, etc. The further processing then proceeds in the customary business manner.

The particular business management advantage is that the technician on site is relieved of activities which are necessary from a business arrangement standpoint but are prone to errors and are not done particularly willingly by the technician, such as e.g. filling in forms, etc.

The data acquisition is effected without a time delay. It goes without saying that the further advantage resides in the subsequent automatic further processing of these data.

Further advantages are that the data that have been input can be immediately checked, and if necessary corrected as well, online.

In a preliminary summary, the invention provides for a system for the management of products and product parts and the assigned identifiers, such as serial numbers, and also for the monitoring and control of the operations during the repair of devices or sites which contain the products or product parts. The serial numbers and associated material master data are stored in a database. If a device or a site is to be repaired, an associated first database extract is created from the database. The extract contains the serial numbers and associated material master data and includes the warranty data of the device or site. A symbol or a series of symbols (image) are created from the data of the first database extract, and can be represented on an input and output device and are stored in an image data memory. One or more serial numbers of the device or of the site are input into the input and output device for the purpose of data adjustment. The product or product part to be repaired is removed as a repair part and a replacement part (spare part) with its serial numbers is input into the input and output device and stored. An altered image is thus produced and an altered database extract corresponding to the repaired device or site is generated from said altered image. The altered database extract is stored in the database memory.

Other features which are considered as characteristic for the invention are set forth in the appended claims.

Although the invention is illustrated and described herein as embodied in a system and a data processing system for the management of products and product parts, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic diagram showing a variety of systemic functional units in a telecommunications context of the invention;

FIG. 2 is a diagrammatic flowchart illustrating an overview of the system flow;

FIG. 3 is a table with serial number information;

FIG. 4 is a data flow diagram illustrating a serial number check;

FIG. 5 is a data flow diagram illustrating various types of serial number transfers;

FIG. 6 is a schematic diagram illustrating warranty claim handling according to the invention;

FIG. 7 is a schematic diagram illustrating a parts life cycle management organization;

FIG. 8 is a table with an exemplary serial number history;

FIG. 9 is a schematic view of a variety of distributed system members and their communication in accordance with the invention; and

FIG. 10 is a schematic flow diagram illustrating the storage contents of the database.

### DESCRIPTION OF THE PREFERRED EMBODIMENTS

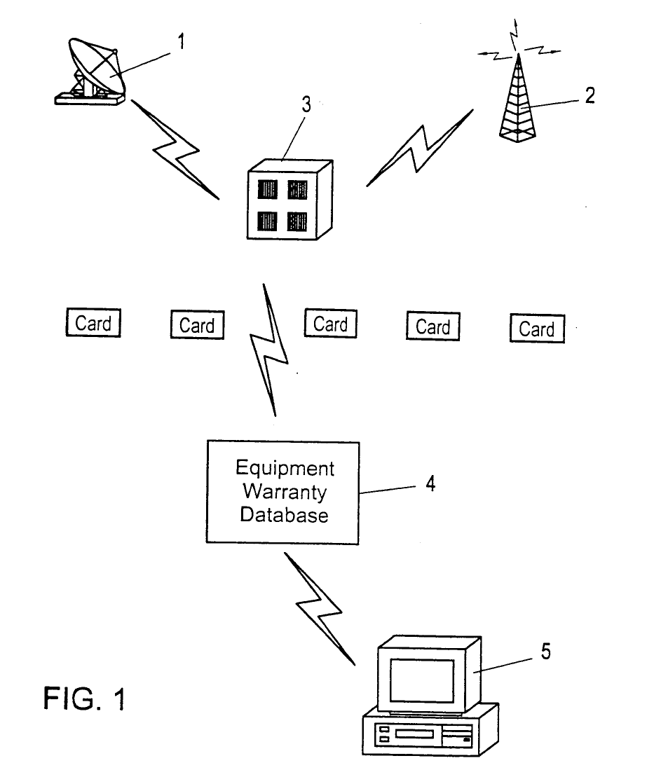

Referring now to the figures of the drawing in detail and first, particularly, to FIG. 1 thereof, there is shown the structure of a system with technical installations to which the invention pertains, namely, a satellite antenna 1 and a transmission tower 2 defining a functional location. Data are exchanged for instance via a radio link between the telephone site 3 and the functional locations. By way of example, the.transmission tower 2 reports the malfunction of a part to the telephone site 3. A database extract 4 corresponding to the transmission tower 2 is created from the equipment master data stored in a database and is communicated as equipment warranty database to the workstation 5, where the warranty data of the defective part are processed further.

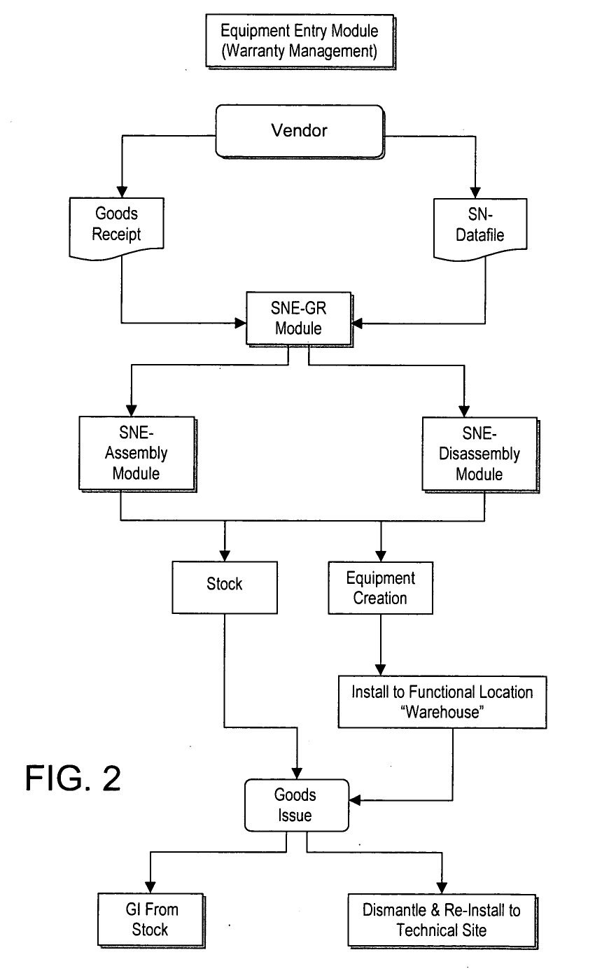

FIG. 2 shows a flow diagram by way of the overview of the management system used here for the serial numbers and material master data, including the warranty data, that are assigned to the products or product parts.

The diagram shows the temporal flow of the products and the serial numbers associated herewith to the enterprise. The goods item passes from the vendor via goods receipt to the goods receipt module SNEGR module (SNEGR, Serial Number Entry Goods Receive module). The goods receipt may be accompanied by a serial number data file (SN data file) concomitantly supplied by the vendor.

The present invention begins practically already at goods receipt. The initial acquisition of the serial numbers is effected in the SNEGR module. This module permits the corresponding serial numbers to be assigned to the received goods and stored in a database. The data that have been input are already checked during inputting and assignment. The serial numbers are usually prescribed by the vendor. It is only in special cases that new serial numbers have to be created.

The following are checked, by way of example:

whether the serial number is already present;

plausibility check;

correctness of the numbers or number/letter combination;

check as to whether type and number of the serial numbers correspond e.g. to the order;

and all further checking possibilities in this area.

In most cases, the product is forwarded to the inventory stock (MM stock).

In the telecommunications industry, but also in other sectors, there exists a peculiarity in that sometimes the devices are assembled from various supplied parts and also disassembled. The two modules SNE assembling module and SNE disassembling module are provided for these steps.

In the SNE assembling module, the acquired serial numbers of the product parts (in the SNEGR module) are combined with a serial number of the product as leading serial number and stored in a database. In principle, any of the serial numbers used may be provided as the leading serial number. The externally visible and thus inspectable serial number, e.g. the call number of the mobile telephone, is usually taken for this purpose.

The SNE disassembly module is primarily of interest for the area of repairs and installation. The individual parts of assembled devices, with the serial numbers of said individual parts, are acquired and stored, which, under certain circumstances, may also necessitate disassembling the product.

In the goods issue module, upon delivery of the product, the leading serial numbers are taken out of the database or identified as issued. At the same time, the serial numbers of the other component parts that are combined therewith are taken out as well.

The acquired parts are in stock or the nearer hierarchical assignments concerning the serial numbers are stored in the database.

In the sub-branch Equipment Creation, the individual parts may be put into a specific hierarchy with respect to one another. Here it is possible e.g. to check that the situation in which, in a technical equipment of one company with five insertions, six equipments of another company are assigned as insertable does not arise.

In the goods issue module, the assembled device is either installed, that is to say arranged as intended (left-hand branch GI from stock) or, in accordance with the right-hand branch, dismantled from the stock and installed at the installation location (e.g. in a transmission tower of the radio network).

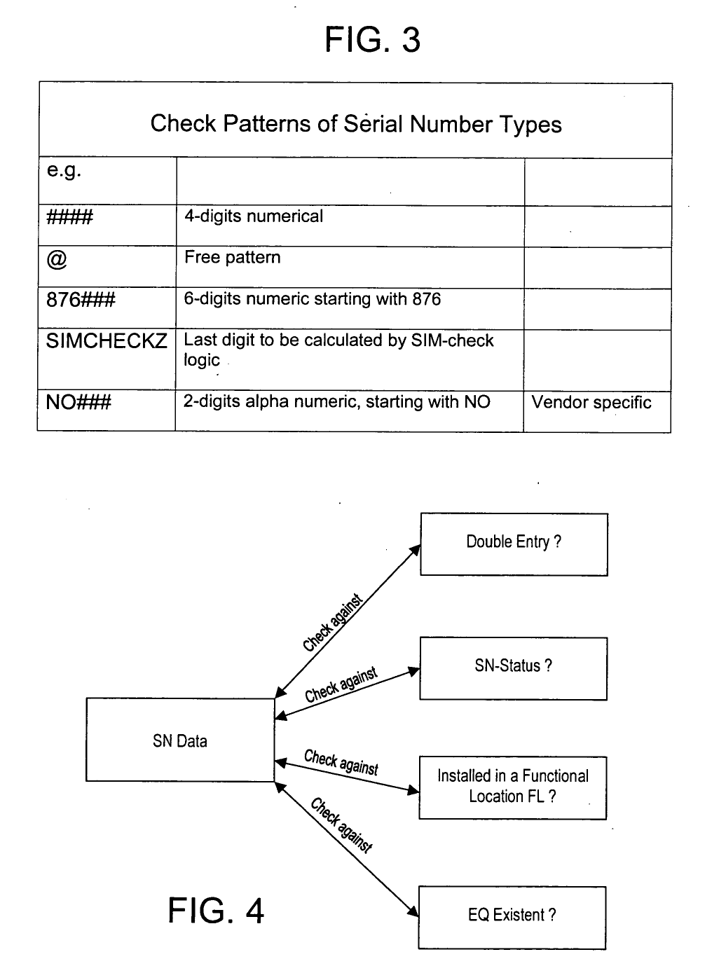

FIG. 3 shows examples for checking the serial number types (SN types). The checks usually proceed in two directions. First of all the number itself is checked as to whether it corresponds to the number type, as to whether it can be correct, etc. There are check patterns for this. Furthermore, the handling of said number is checked, e.g. double allocation of the same number, etc.

The first row shows the check as to whether the serial number consists of four digits. The symbol of the second row denotes an arbitrary character. The logic according to row 3 checks whether the serial number is a 6-digit number starting with the digits 876. The abbreviation SIMCHECKZ is a command for checking the number according to a check logic for SIM card numbers. The last row checks for five alphanumeric characters, starting with N0.

FIG. 4 illustrates the second part of the number checking, namely the handling of the numbers. Here a check is made to establish whether and how the serial number fits in the environment.

The check for double entry shows e.g. whether a number has inadvertently been scanned in twice. The SN status shows for example whether the part bearing this number has already been delivered to a dealer, so that a new entry of this part cannot be correct. Furthermore, it may be checked whether the part is already installed in a transmitting station, which is equivalent to a status check (in the module installed in a functional location FL). The check as to whether the part already exists in the database (EQ existent) is illustrated as a further example.

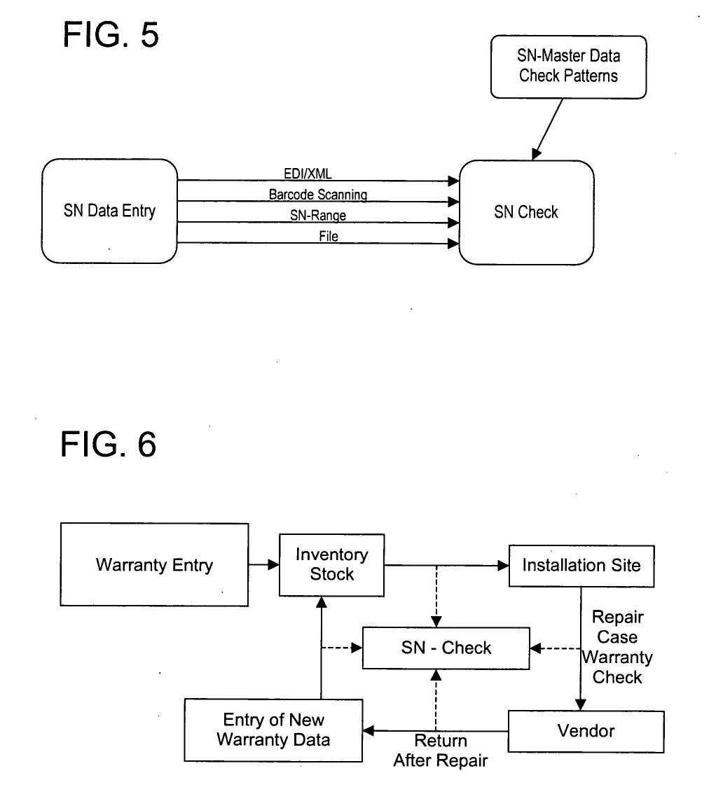

FIG. 5 shows an overview of possibilities for the electronic transfer of serial numbers. EDI XML means Electronic Data Interchange markup language. This may be e.g. file transfer via the Internet or some other electronic data interchange according to the XML standard. The inputting by means of bar code scanning is effected, according to the prior art, by means of hand-held devices or scanner machines. SN range means that not every serial number is input by itself, rather that, in the event of a delivery, a serial number range is specified, the concrete serial number then being assigned to each part within the present system. The right-hand part of FIG. 5 illustrates that the transferred data are checked in the SN check module, to be precise using the SN master data check patterns as are listed for example in FIG. 3.

FIG. 6 schematically shows the warranty handling according to the invention.

In the module initial goods receipt, during the goods receipt, the warranty data are also entered into the database and the goods item is in stock. For the installation (consumption) of a part from the stock, this part is installed in the site. In the repairs case, the warranty data are checked in respect of whether or not the repair is warranty case. In any event, the part is returned to the vendor. The latter redelivers the repair part (returns from repairs), in which case in the module second goods receipt as goods receipt module, the new warranty data are entered into the database and the part is put back in stock. In all these operations, a serial number check may take place in each case in order to ensure that the correct parts are handled in each case.

The SN check may always be connected with the customary plausibility checks as enumerated for example in FIG. 3.

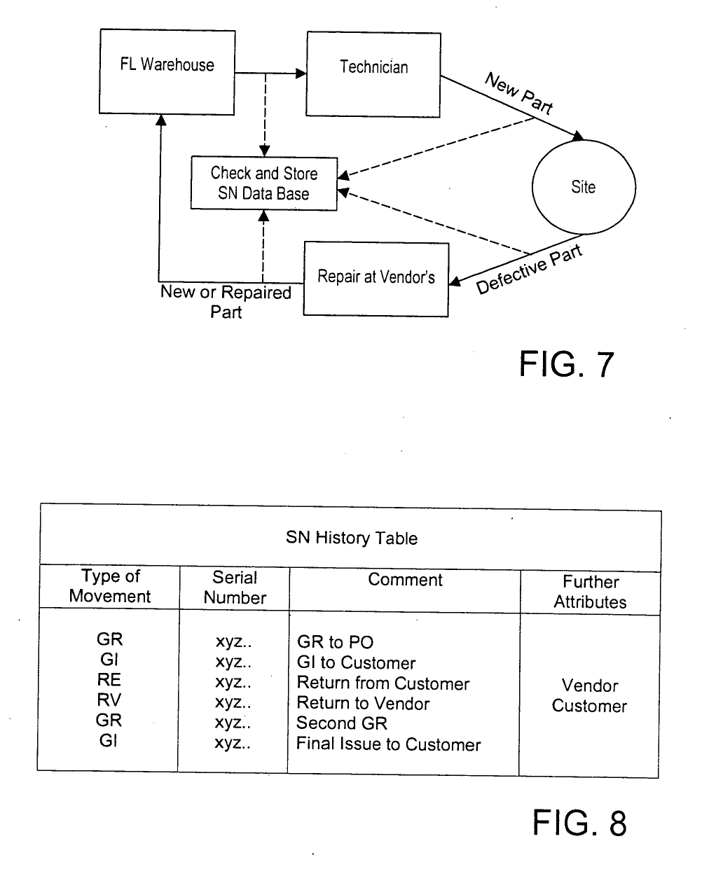

FIG. 7 shows the spare parts lifecycle management.

The technician takes a spare part from the stock FL warehouse and brings it as new part to the site to be repaired, where the defective part is disassembled and replaced by the new part. The defective part passes to the vendor via a repair order, in order to be repaired there (repairs at vendor). The repaired fault returns from the vendor either as such a repaired part or as a new part back into the stock FL warehouse. All these steps are checked and stored in the serial number database. As in all other movements of parts, the checking is effected by way of the serial numbers and, furthermore the history of each part is updated.

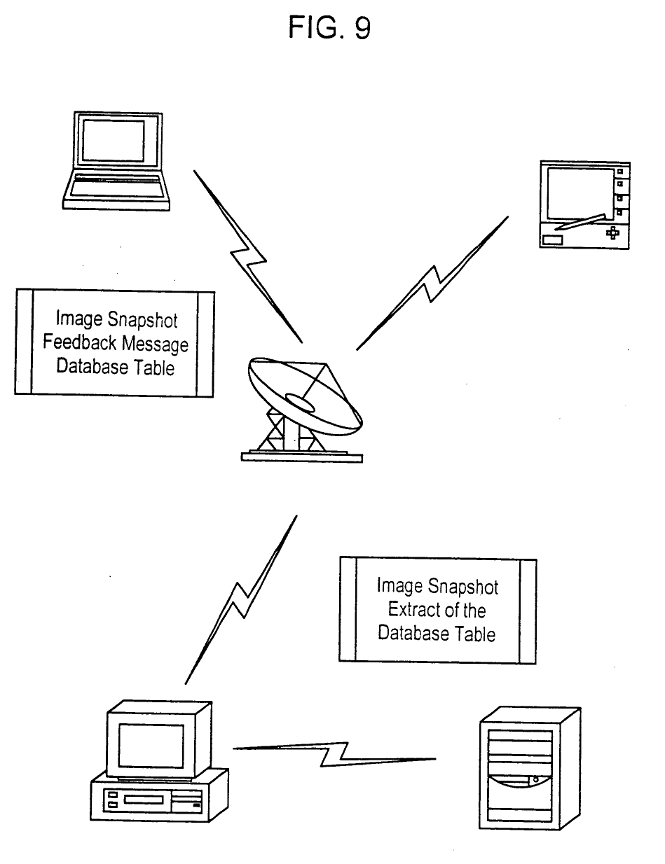

FIG. 8 is an exemplary list of history records. FIG. 9 shows an important part of the system according to the invention, in which case, for a part to be repaired, an extract is created from the database table stored in the input device and a so-called image snapshot is formed from this. The image snapshot is transferred to the technician on his laptop or palmtop, e.g. via a satellite antenna. It goes without saying that any other data transfer can also be effected. If, say, one of the transmission towers of a telecommunications system with 5000 transmission towers has to be repaired, the technician who is on the way to that transmission tower receives the specifically assigned data concerning the parts installed in that transmission tower. In the repair case, the changes are entered via the laptop or palmtop and a feedback message is effected via the corrected image snapshot to the database table, which is thus updated.

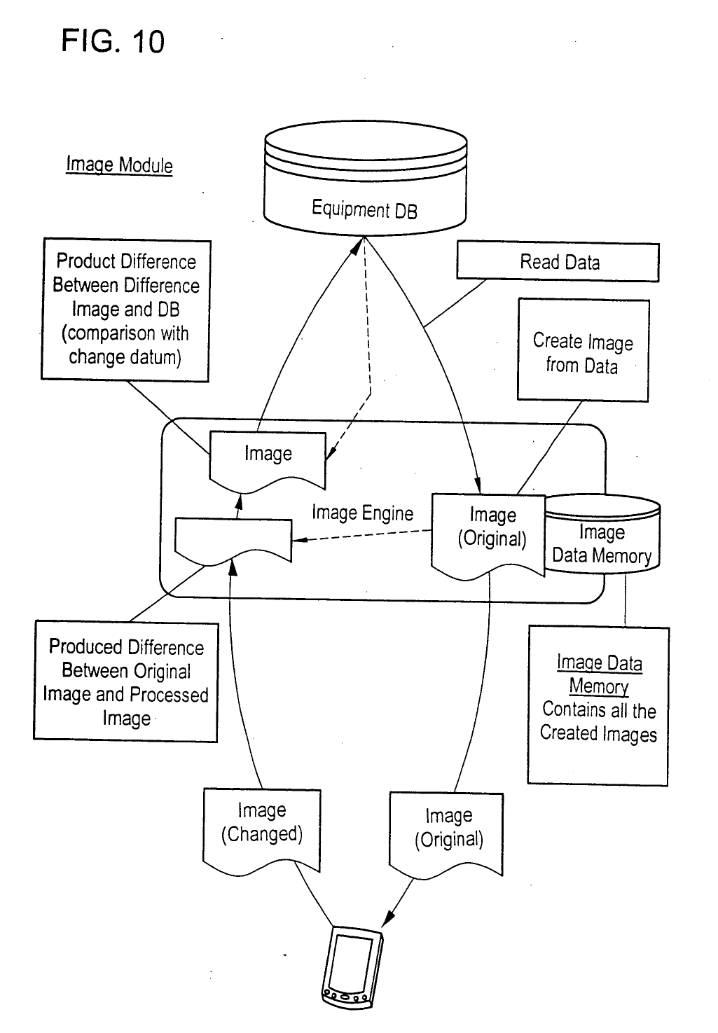

FIG. 10 schematically illustrates the method of operation of the image module. The central component part is the image engine. As described above, the data records assigned to the site to be repaired are taken from the database equipment DB. In the image engine, associated symbol images are created from the data records, the symbol images being taken from an image data memory. Said image data memory contains various image symbols or text symbols, which are more readily comprehensible to the technician and may be the case with anonymous serial numbers. The original image is transferred to the technician prior to the repair of a part, so that he can infer the prevailing basic state of the site on his laptop.

When the defective part is dismantled, the technician can scan in the serial number of the defective part or input it into his laptop. A check may then immediately be made as to whether he is actually at the correct site. When the spare part is installed, the image is changed on the laptop and the difference between the original image and the processed image is evaluated in the image engine. The new image is transferred to the equipment DB in order that the new state is stored there. It goes without saying that the corresponding entries are also made in the history file in the process.

The invention has been described above with reference to a distributed hardware implementation utilizing serial number assignments as the unique identifiers of the products and product parts. It will be understood that a variety of alternative identifiers are equally possible for the realization of the invention (the terms identifier and serial number should be understood as interchangeable and in accordance with their broadest meaning). Further, it is also understood that the invention is implemented in a software system and it may be realized in a computer program product or a mixed software and hardware system. Data carriers are provided for that purpose, which include all computer-readable media such as, inter alia, any kind of computer memory device, floppy disks, hard disks, optical and magnetic devices, CD-ROMs, Flash ROMs, non-volatile and volatile ROMs and PROMs, RAM, as well as carrier waves of transmission signals, and the like.

I claim:

1. A product management method for managing products, product parts, and identifiers associated with the products and product parts, and for monitoring and controlling operations during a repair of a device or site containing the products or product parts, wherein the identifiers and associated material master data are stored in a database, the method which comprises:
generating a first database extract representing the device or site to be repaired from the database, the extract containing the identifiers and associated material master data including warranty data of the device or site;
generating a symbol or an image from the data of the first database extract, the symbol or image being displayable on an input and output device and storable in an image data memory;
inputting one or more serial numbers of the device or of the site into the input and output device for data adjustment;
removing the product or product part to be repaired as a repair part and inputting the spare part, with the identifier, into the input and output device and storing the information;
generating an altered image and generating an altered database extract corresponding to the repaired device or site from said altered image; and
storing the altered database extract in the database memory.

2. The method according to claim 1, wherein the identifiers are unique serial numbers and serial number combinations.

3. The method according to claim 1, which further comprises:
determining whether or not a warranty case is present in the database with respect to the repair part;
delivering the repair part to a vendor as a warranty case or as a repair case without warranty, whereupon the vendor returns the part as a new part or as a repaired part;
supplying the repair part to inventory stock via a goods receipt module and storing in the data memory; and
storing new warranty data of the repair part in the data memory.

4. A data processing system for managing products, product parts, and identifiers associated with the products and product parts, and for monitoring and controlling operations during a repair of a device or site containing the products or product parts, wherein the identifiers and associated material master data are stored in a database and warranty data form part of the database, the system comprising:
a processing module for providing a first database extract associated with the device or site to be repaired from the database, the first database extract containing the identifiers and associated material master data of the device or site;
a processing module for creating a symbol or image from data of the first database extract and storing in an image data memory, wherein the symbol or image is configured for display on an input and output device;
at least one input and output device configured for input of one or more identifiers of the device or the site for the purpose of data adjustment;
a processing module enabling a product or product part to be repaired to be removed as a repair part, whereupon an identifier of a spare part is input into said input and output device and stored;
a processor for generating an altered image and for generating an altered database extract corresponding to the repaired device or site from the altered image; and
a device for storing the altered database extract in the database memory.

5. The system according to claim 4, wherein the identifiers are unique serial numbers and serial number combinations.

6. The system according to claim 4, wherein said processor module and said device for storing are contained in a single system module.

7. The data processing system according to claim 4, wherein the system is configured to:
determine whether or not a warranty case is present in the database with respect to the repair part;
deliver the repair part to the vendor as a warranty case or as a repair case without warranty and forwarded by the vendor as a new part or a repaired part;
supply the repair part to inventory stock a goods receipt module and to store in the data memory; and
store new warranty data of the repair part in the data memory.

8. The data processing system according to claim 4 implemented as a distributed system with a plurality of modules and at least one mobile input and output device.

9. A computerized warranty management system, comprising a plurality of modules configured to perform the method according to claim 1.

10. A computer-readable medium having stored thereon computer-executable instructions for performing the method according to claim 1.
